(19) United States
(12) Patent Application Publication
(10) Pub. No.: US 2007/0106523 A1
(43) Pub. Date: May 10, 2007

(54) Information system and method for generating appraisal reports for real properties

(76) Inventors: James M. Eaton, Laguna Beach, CA (US); Brian Eaton, Long Beach, CA (US); Mark Ronai, Dana Point, CA (US)

Correspondence Address: PATENT LAW & VENTURE GROUP, 2424 S.E. BRISTOL, SUITE 300, NEWPORT BEACH, CA, 92660, US

(21) Appl. No.: 11/498,597

(22) Filed: Aug. 2, 2006

Related U.S. Application Data
(60) Provisional application No. 60/734,687, filed on Nov. 7, 2005.
(60) Provisional application No. 60/734,688, filed on Nov. 7, 2005.

(51) Int. Cl. G06Q 99/00

(52) U.S. Cl. 705/1

(57) ABSTRACT

A system and method for facilitating appraisals is disclosed. A lender and/or customer may request an appraisal from a manager or administrator, by posting the request to an Internet site form. The manager checks the schedules of local appraisers, selects an appraiser and schedules the appraisal. Once the appraisal has been completed, the appraiser uploads the appraisal information making the information available to the requestor or other customer. The requestor can access the system information at any time from any computer with internet access. The manager may also store the appraisal and information about the uploaded appraisal for analysis regarding the appraised property or the appraiser's work product.

### CROSS-REFERENCE TO RELATED APPLICATIONS

This application claims priority of U.S. Provisional Patent Application Ser. No. 60/734,687, filed Nov. 07, 2005, and also claims priority of U.S. Provisional Patent Application Ser. No. 60/734,688, filed Nov. 7, 2005, both of which are incorporated herein by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”

Not applicable.

### BACKGROUND OF THE INVENTION

1. Field of the Present Disclosure

The invention generally relates to systems for the appraisal of real estate properties and more particularly to an Internet hosted, automated, information system capable of handling a large volume of real property appraisals.

2. Description of Related Art including information disclosed under 37 CFR 1.97 and 1.98

Generally speaking, the real estate appraisal industry is labor intensive. Typically, a representative of a lender, as for instance a mortgage broker, telephones an appraiser and schedules an appraisal for a residential or commercial property. The appraiser schedules the job and in turn, inspects the property, fills out appraisal forms, and mails the forms to the lender. The problem with this arrangement is the number of delays associated with finding an appraiser, scheduling the appraisal, and mailing the forms to the lender. This traditional method does not meet the needs of the current lending industry which is volume oriented and suffers ever more-extreme timing and cost constraints.

Others have attempted to provide an electronic solution to the appraisal process as for instance, the EDI solution including REALEC Inc., Primis Inc., United Systems Software Co., the EDI Appraisal Network, FNC, Inc. and realink.com. Each of these appraisal management companies has adopted Fannie Mae's X-12 EDI format for the ordering and delivery of appraisal reports. Please see “Appraisal Network Picks EDI Format”, National Mortgage News, Nov. 8, 1999, p.8. This format allows the transmission of documents electronically, but does not provide access to individual pieces of information within the document. Therefore, while it does speed the process of transmitting information, the workflow remains relatively unchanged.

A further problem is that lenders are not equipped to properly manage outside appraisal service organizations. Accordingly, an appraisal system is needed that produces high quality appraisal reports on a large scale with short lead time. The following references are directed to the needs of the real estate property appraisal industry.

Robbins, U.S. 2001/0039506, discloses a real estate appraisal method wherein a database of enhanced records of properties in the same territory as the subject property is used to derive market-driven value adjustment rates for property attributes and time differentials. The adjustment rates are applied to the properties in the database, the most similar comparable properties are selected on the basis of similarity in property attributes and the market value is then estimated from the selected most similar comparable properties. The resulting valuation is supportable by market conditions and can be printed on specified forms.

Beam et al., U.S. 2002/0002494, discloses a system and method for facilitating appraisals. A lender and/or customer may request an appraisal from a hub. The hub checks the schedules of local appraisers, selects an appraiser and schedules the appraisal. Once the appraisal has been completed, the appraiser uploads the appraisal information and the hub transfers the information to the requestor or other customer. The hub may also store the appraisal and information about the uploaded appraisal for analysis regarding the appraised property or the appraiser's work product.

Brock, Sr., U.S. 2002/0035535, discloses an interactive, computer-implemented system for providing a comparison of at least two real estate properties The system includes a database that stores a plurality of data relating to real estate properties. The data includes at least one of address data, ownership data, size data, geographic location data and monetary value data. An interface system enables a system user to input a request for a comparison of at least a portion of the data for at least two of the real estate properties. The request includes information sufficient to identify the real estate properties to be compared. A processor uses the information to obtain a comparison of the data relating to the real estate properties. A delivery system provides to the system user a comparison of the data relating to the real estate properties.

Pianin, U.S. 2002/0062218, discloses a system for managing commercial real estate property by providing access to multiple commercial real estate services using an on-line property management environment. The on-line property management environment comprises a distributed computer network, such as the global Internet, coupled to numerous clients, a property services server platform connected to a local database, and numerous property information databases. The on-line property management environment improves the efficiency and effectiveness of commercial real estate transactions by providing a Web site that can serve as a commercial real estate professional's workspace to obtain industry specific content, use support tools, benchmark performance, and access vendors in a personalized environment. The Web site can facilitate the offering of multiple services relating to the property management including site appraisal, engineering, and environmental services in an on-line computing environment such as the global Internet.

Wheeler, U.S. 2004/0039581, discloses system for managing the sale of real estate that includes a first step of providing a computer server that is accessible via a global computer network. In a second step there is provided on the computer server a real estate database that contains property listings that are being offered for sale by Real Estate Agents and Independent Sellers. In a third step there is provided on the computer server a transaction database that is adapted to store sale documentation relating to the sale of a real estate listing. In a final step, sale documentation relating to a property listing is received in the transaction database. The transaction database is then automatically updated so that a buyer and dealer and others can monitor the progress of a sale.

Shinoda et al., U.S. 2004/0049440, discloses a real estate appraisal auxiliary system and the like that comprise a map database storing unit for storing a map database comprised by relating land value information and urban planning drawing information on a plurality of locations with their position coordinates on a map, a use zoning obtaining unit for obtaining the use zoning of a location to be appraised from the urban planning drawing information if the location to be appraised has been specified on a map, a land value information retrieving unit for retrieving land value information comparable with the location to be appraised based on the use zoning obtained by the use zoning obtaining unit, and a standard land value calculation unit for calculating a standard land value for the location to be appraised based on the land value information retrieved by the land value information retrieving unit.

Modi, U.S. 2005/0071376 and 2005/0080702, disclose a computer network that uses a central database to manage a portfolio of real property holdings. The real property information related to the portfolio is stored on the central database and organized into a plurality of information categories. A computer hosts a website for users to access the central database and view one or more categories of the real property information. Each authorized user can edit the real property information and save the edited real property information back to the central database. Other users access the edited real property information from the central database. The central database can also be used to compile real property information for offering as collateral in a loan package. The lender is given access to the real property information through the website. The real property information as selected for review by the lender is made available on the website.

Diesch et al, U.S. 2005/0209867, discloses a computerized method of searching property records relating to a specific parcel that includes receiving property record data for a plurality of parcels into a computer system. The property record data relates to source property record documents. The method also includes storing the property record data in a searchable database and receiving into the computer system an identifier. The method further includes using the identifier to search the database and select from the property record documents a set of relevant documents relating to the parcel. The method also includes using the set of relevant documents to produce a data summary and outputting the data summary from the computer system. The data summary comprises information from which an underwriter can underwrite a title policy, using commonly-accepted title policy underwriting rules, without reference to the source documents, or images thereof, from which the data summary originated.

Dwight, WO 02/19216, discloses a system that relates generally to the delivery of real estate sales price information, identification, and comparisons of comparable real properties, and sales price predictions. In particular, the invention relates to Web-based services for providing historical real estate sales information, trend analysis, comparable market analysis, buy/sell signals, and individually tailored appraisals. The term “appraisal” means herein an estimated appraisal (predicted sales price), as opposed to a formal appraisal prepared by a certified or licensed appraiser.

The present disclosure distinguishes over the prior art providing heretofore unknown advantages as described in the following summary and detailed description.

### BRIEF SUMMARY OF THE INVENTION

This disclosure teaches certain benefits in organization and use which give rise to the objectives described below.

The present invention provides an information system and method for managing a large volume of requests for real property appraisals and for generating and delivering corresponding appraisal reports. The system uses a wide area network, preferably the Internet, to provide to all of the necessary human factors and data sources, a single operating host information site (“Site”) programmed to operate in a manner that achieves the objectives described. The Site is made available, via the Internet, to users including: clients, administrators, and appraisers. The clients are typically representatives of lending institutions, the administrators are employees of Site host, and the appraisers are typically independent professional real estate appraisers and report generators. Others, such as sales professionals also have access to the Site for information purposes. The present invention is distinct from the prior art in that all information and steps, from sales, to order placement and handling, report generating and delivery is conducted using the Site alone without the need for any other resource.

A primary objective inherent in the above described system and method of use is to provide advantages not taught by the prior art.

Another objective is to provide an information system capable of more effectively and efficiently providing property appraisals;

A further objective is to provide such a system utilizing an Internet hosted site that fulfills every aspect of the communication, research, analysis, and report generating necessary to fulfill real estate appraisal reporting business.

A still further objective is to provide such a system that is able to handle and manage a large volume of such appraisal reporting business.

A yet further objective is to provide such a system that is able to operate in a highly automated manner.

A still yet further objective is to provide such a system that is able to provide more accurate and error free appraisal reports.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one preferred embodiment of the present invention In such drawing(s):

FIG. 1 is a block diagram showing the important components of the present information system;

FIG. 2 is a block diagram showing the important steps in the preferred method used in the operation of the information system;

FIG. 3 is the log on screen of the graphical user interface of the web site hosting the information system;

FIG. 4 is the new user registration screen thereof;

FIG. 5 is the new order entry screen thereof;

FIG. 6 is the orders status screen thereof;

FIG. 7 is the management screen showing users thereof;

FIG. 8 is the administrator screen showing orders thereof;

FIG. 9 is the search screen thereof;

FIG. 10 is the appraiser's screen;

FIG. 11 is the comparables search input screen thereof;

FIG. 12 is the comparables search results screen thereof;

FIG. 13A and 13B are the search results edit screen thereof;

FIG. 14 is the non-conclusive generation screen thereof; and

FIGS. 15A, 15B, 16 and 17 are pages of a typical report generated by the information system.

### DETAILED DESCRIPTION OF THE INVENTION

The above described drawing figures illustrate the described apparatus and its method of use in at least one of its preferred embodiments, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation on the scope of the present apparatus and method of use.

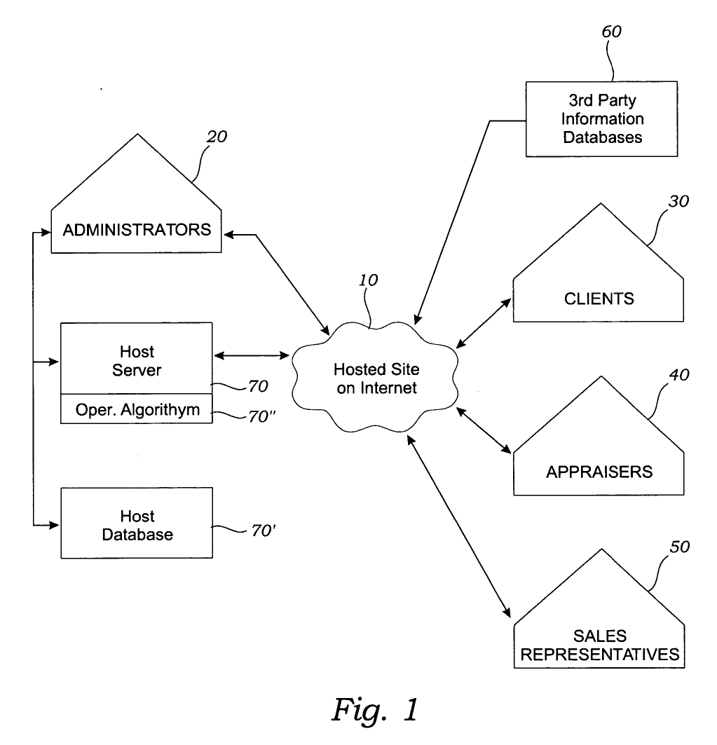

The present invention is a system and method of operation for producing real estate property appraisals which shall be referred to as “reports” in this description. The system as shown in FIG. 1 is made up of an Internet hosted web site referred to herein as Site 10, and several groups of individuals, referred to herein as “users” who are in Internet communication with the Site 10, typically via their own local computer systems and networks, including: administrators 20, clients 30, appraisers 40, and sales representatives 50. The system also includes third party information databases 60 which are able to be accessed and selected information retrieved and downloaded through Site 10 to host server 70, the information being stored in host database 70′ within a mass storage device. In fact, administrators 20, clients 30, appraisers 40, and sales representatives 50, the users, all communicate with the host server 70 through the Site 10 using Internet protocols as is well known in the art. Certain of the administrators 20 have direct access to host server 70 and host database 70′ for maintenance, upgrade and other caretaker or management functions. The Site 10, host server 70 and database 70′ all function as directed under the server's operating algorithm 70″.

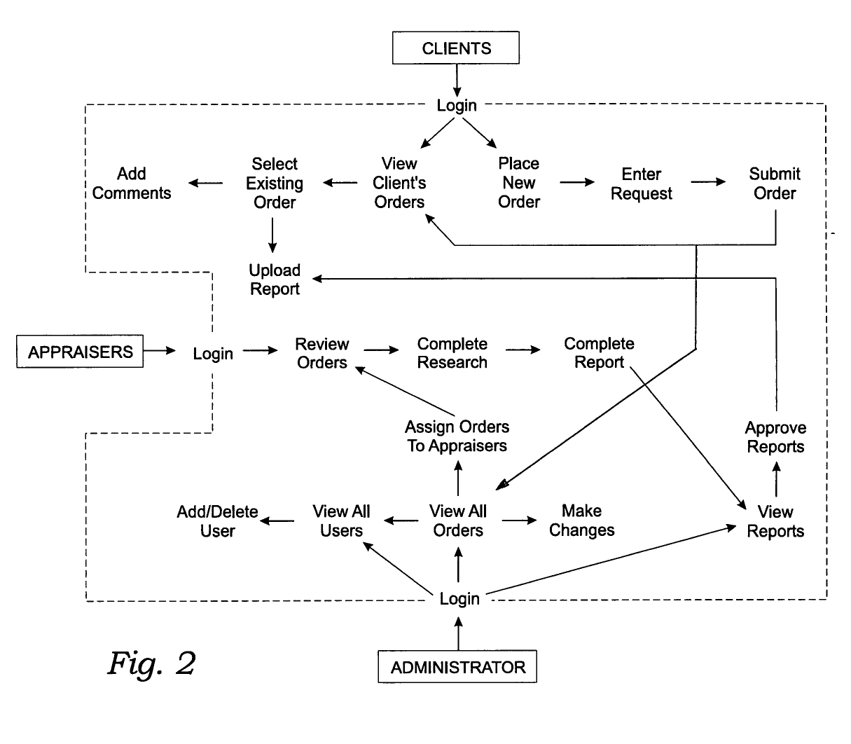

The method of the present invention is illustrated in FIG. 2 and is executed by the operating algorithm 70″ through host server 70 and the Site 10. The method is capable of receiving information, storing the information in a form capable of being viewed by the users, organizing the information into reports and transferring the reports in a form that may be viewed and printed. The Site 10 receives requests from the clients 30 for reports. The reports are prepared by appraisers 40 and placed in a form that may be accessed by the clients 30. In the industry that applies information and facts about real estate, reports of various types are able to fulfill different objectives. Such reports may take the form of formal property appraisals generally requiring a physical inspection of the subject real property by a Certified Property Appraiser. Other reports based on secondary research through the third party information databases 60 are also highly useful in this industry and may be made without physical inspections.

Referring to FIG. 2, the primary users of the Site 10 are clients, administrators and appraisers. All users perform their respective activities and communicate with each other via the Site 10. In this way, the present invention is novel with respect to the prior art wherein methods do not focus exclusively on an Internet site but only peripherally. It has been found that the present method, by placing the Site 10 as the sole operating center, achieves a more efficient and effective operation and results than prior art models.

In FIG. 2, we find that once logged onto the Site 10, clients 30 who are primarily lending organizations, may place new orders and view their own list of existing orders to see status. They may add comments, make changes, withdraw orders, enter requests and upload finished reports, among other related activities. Clients 30, typically, need not communicate with other users by phone, fax, email or postal service. The Site 10 fulfils all of the client's needs.

Appraisers 40, after logging onto the Site 10 may review orders, complete research and prepare reports, all actually on Site 10. Again, Site 10 fulfils all of the appraiser's needs.

Administrators 50 may view information about all users, perform housekeeping tasks such as adding and deleting users and changing access levels, view all existing orders, make comments and changes, and view and approve reports. Once approved by an administrator 50, the reports are configured and placed so as to be able to be viewed and uploaded by the appropriate clients 30.

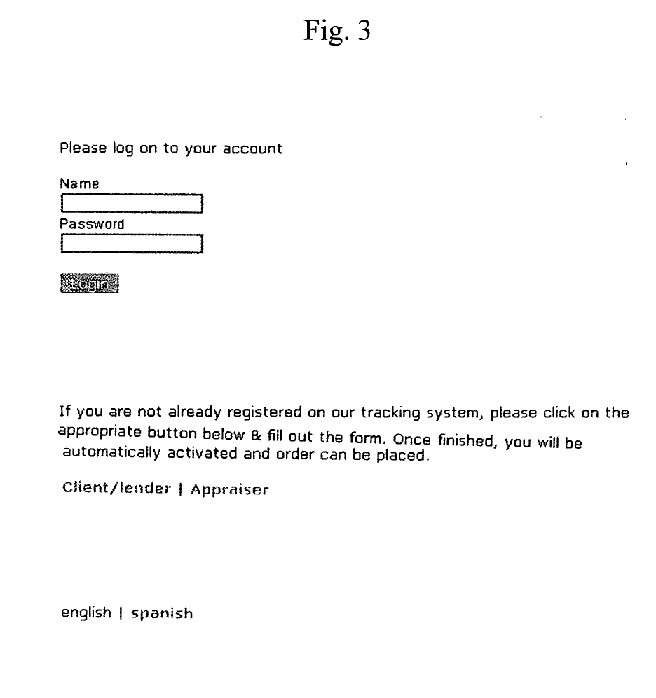

Referring now to FIGS. 3-14 we describe the operating screens that enable the method of the present invention. Although the screens reviewed here could be created and placed into a working web site, such as Site 10 by those of skill, it is the configuration and operations of the present screens that is novel in the present invention especially when considered with their interplay in operation.

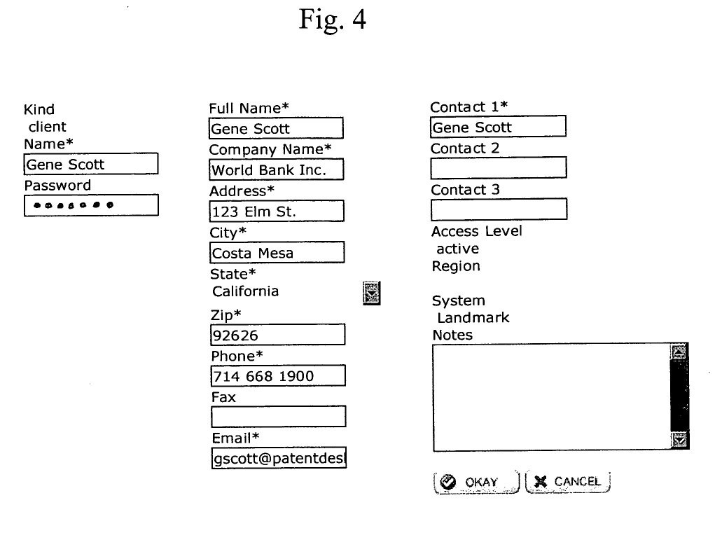

FIG. 3 is the Site's log-in screen for entry to the Site 10 each time after initial registration on the screen of FIG. 4.

FIG. 4 is the Site's new user registration screen for those entering the Site 10 for the first time and logging in as a new user. New user contact information is filled in, in real time dynamically on screen including a user chosen “user name” and password, under which entry to the Site 10 can be achieved subsequently.

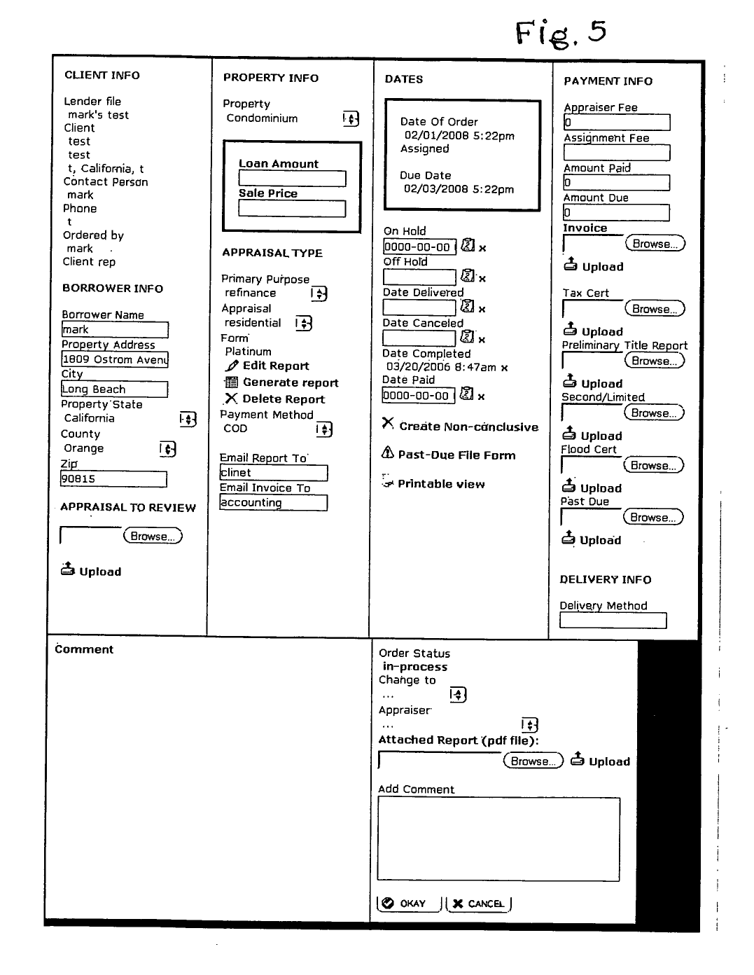

FIG. 5 is the Site's new order entry screen. Clients use this screen to fill in relevant information to establish a request for a report on a described property and this act establishes an individual and separate case file. The essential items filled in by the client are: CLIENT INFO, BORROWER INFO, ACCESS INFO, PROPERTY INFO, LOAN AMOUNT and SALE PRICE, APPRAISAL TYPE, ORDER and INSPECTION DATES, PAYMENT INFO, and COMMENTS. Upper case is used herein to refer to on-screen text.

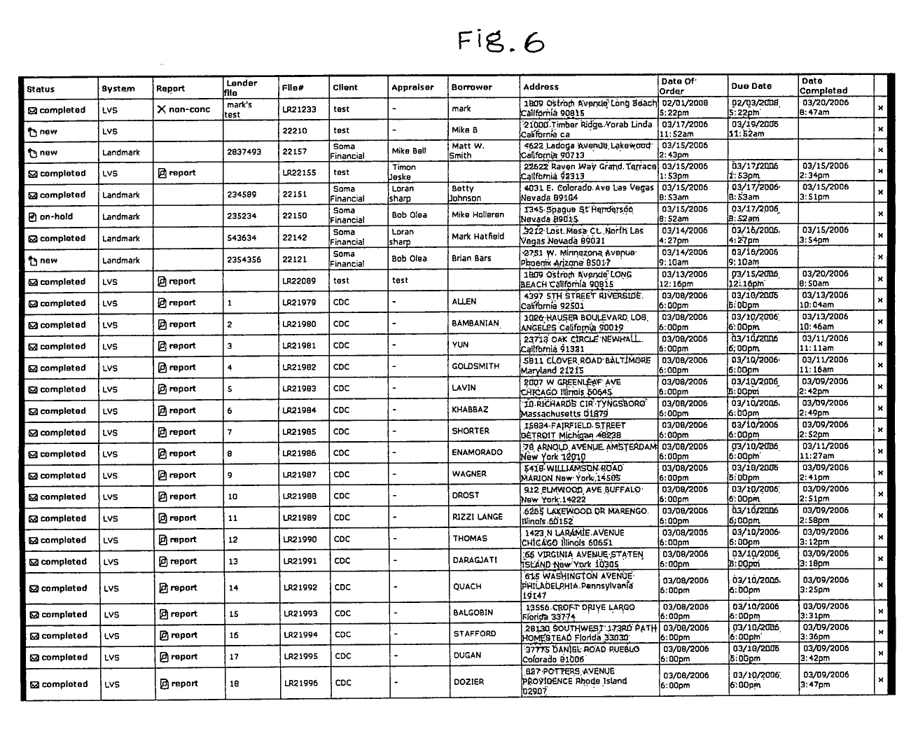

FIG. 6 is the Site's orders status screen whereby clients may view the status of all of their own orders but not those of other clients. This screen presents a list of the client's outstanding orders. The client has the ability to search for an order based on a keyword or an address. Clients can also click on NEW APPRAISAL ORDER to link into the NEW ORDER SCREEN. This screen shows what system the user is using, the lender file number, borrower's name, subject property address, date and time of order and date of order completion. The REPORT column identifies a location where an available appraisal report has been uploaded, and archived in PDF format. The client may view such reports and print them out at any time. Order status for each order will be one of: New, In-Process, On-Hold, Cancelled, Pending, and Complex. The client 30 is able to click on a file in the status column to view the related order screen.

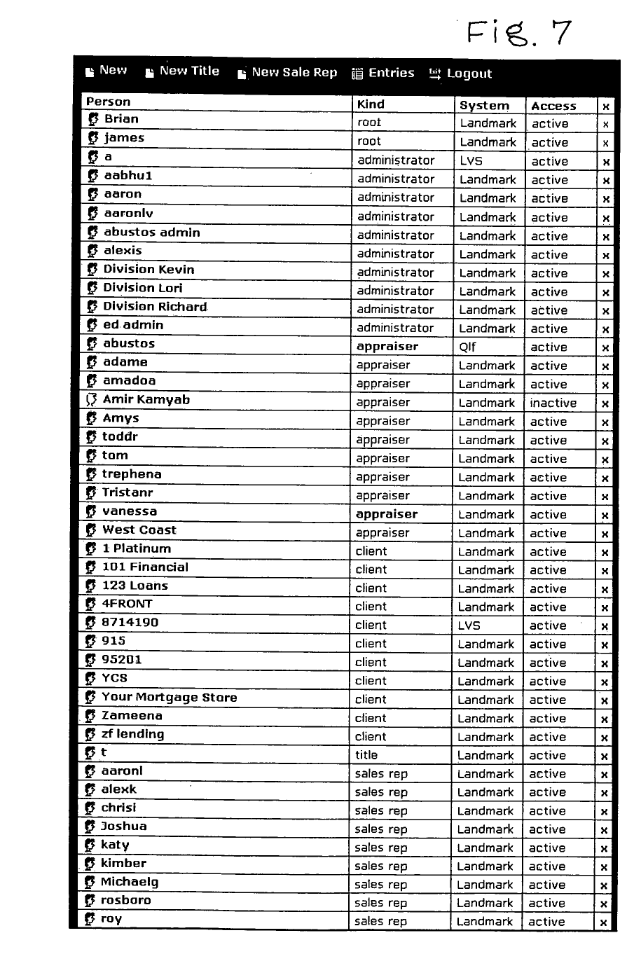

FIG. 7 is the Site's management screen showing active and registered users. Access to this screen can be, and is, normally limited to only certain administrative staff members, i.e., managers. From this screen, access levels of each user may be changed. This screen shows NAME, TYPE OF USER, SYSTEM and ACCESS LEVEL. As previously discussed users are classified as administrator 20, client 30, appraiser 40, and sales representative 50, and each class is assigned an access level whereby they are limited to the type and extent of information on the Site 10 to which they can gain access and functionally need.

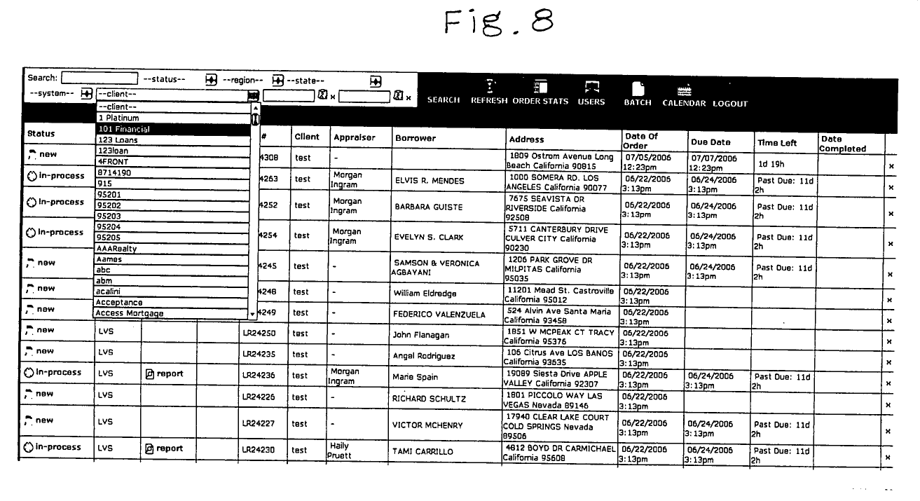

FIG. 8 is the administrator screen which shows orders in two separate sections. The bottom of the page shows all orders from all clients 30. These orders are arranged in rows with order information including STATUS, SYSTEM, LENDER FILE #, CLIENT, APPRAISER, BORROWER, ADDRESS, DATE OF ORDER, DUE DATE AND DATE COMPLETED. The top of the page shows orders that are currently in-process. These orders have a timer associated with them to ensure that they are processed in a timely manner starting with a property inspection. From the top section, the administrator 20 is able to link to other screens on the Site 10. This screen also has a search function enabling a user to search for an individual file by keyword or number.

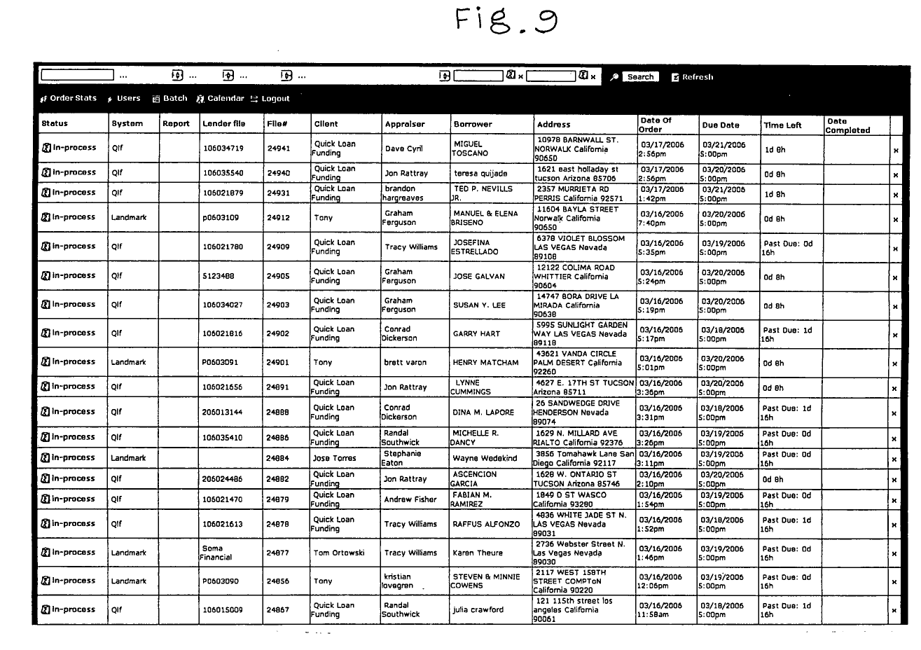

FIG. 9 is the Site's search screen which enables a user to search by any one of several variables, for example: BORROWER NAME, FILE NUMBER, STATUS, ADDRESS, AND DATE OF ORDER.

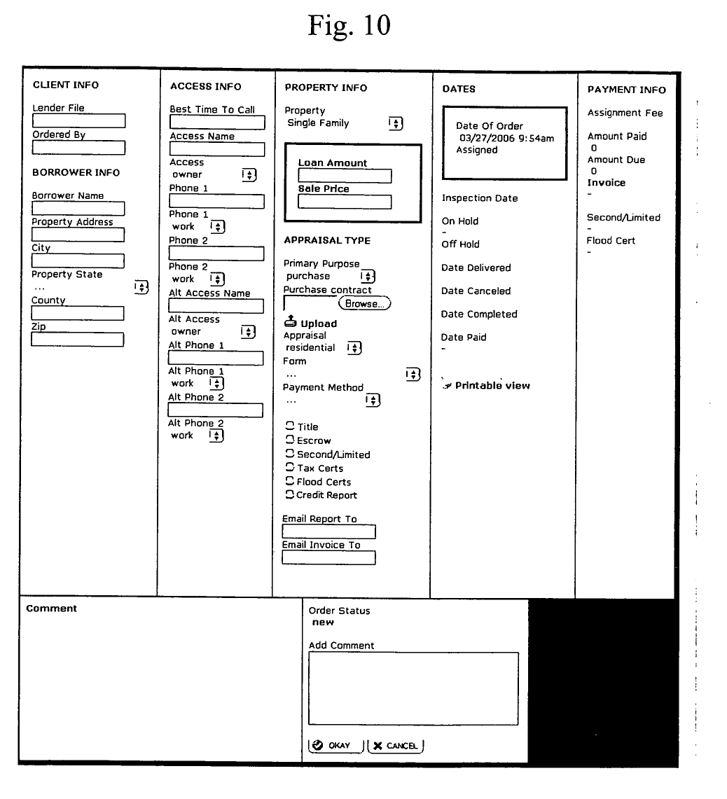

FIG. 10 is the Site's appraiser screen providing the basic information needed to start the appraisal process.

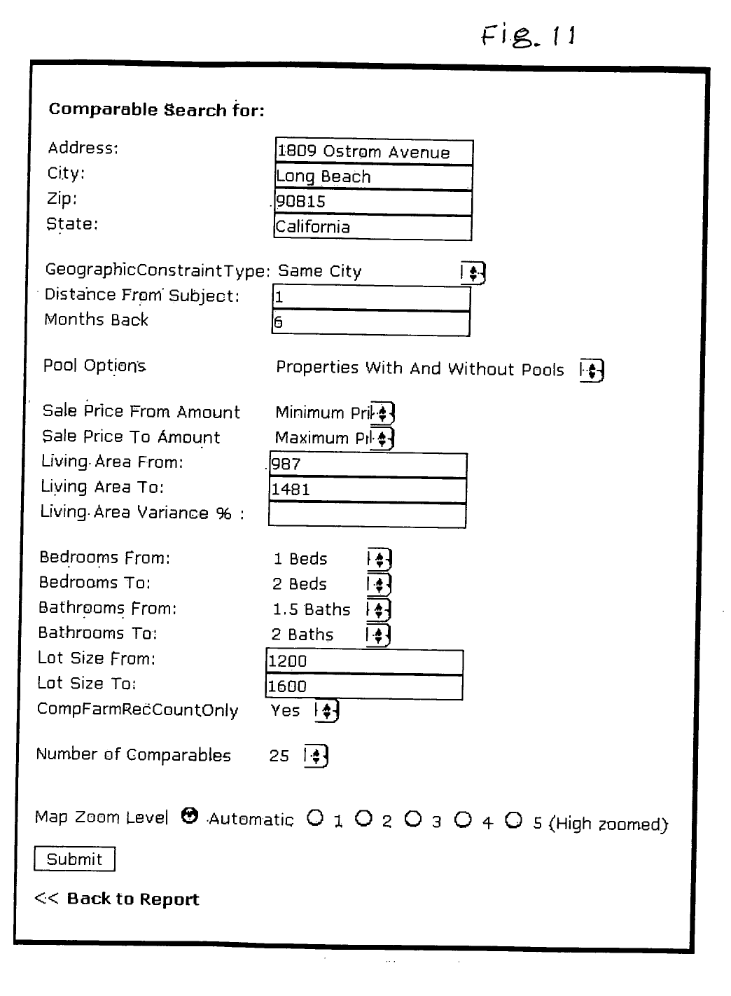

FIG. 11 is the Site's comparables search screen, which enables an appraiser 40 to set parameters for controlling a sales information data search for a subject property. These fields are auto-populated from calculated variances based on details of the subject property. By clicking on SUBMIT, the operating algorithm 70″ searches and retrieves an XML data stream from the third party information databases 60. Relevant data/information falling within the selected search parameters is thereby retrieved.

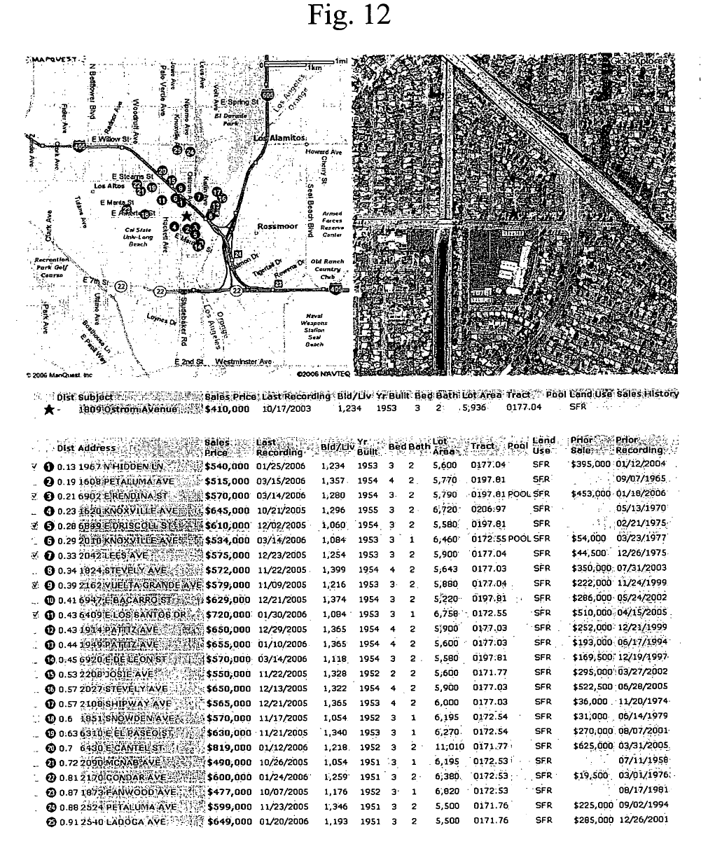

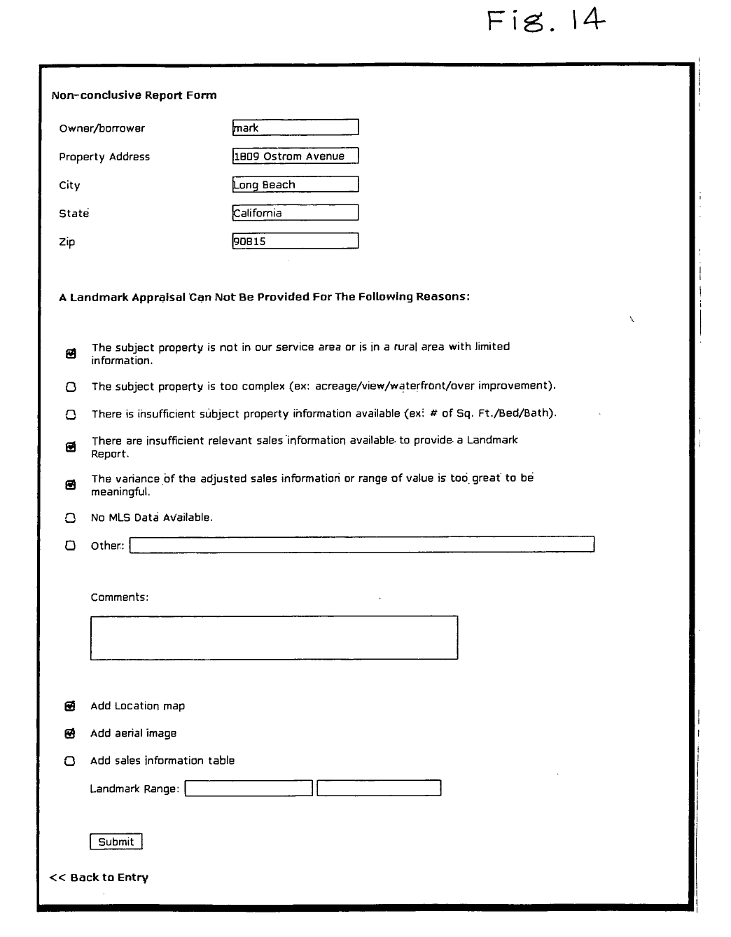

FIG. 12 is the comparables search results screen which shows the data/information result pulled from the third party information databases 60 in XML format. This screen enables the appraiser to select the sales data that will be integrated into the report. The information includes a location map and aerial image of the subject property and the surrounding area. These maps enable the appraiser 40 to distinguish the subject property location in relation to the comparable sales information. This screen also enables the user to set flip risk, marketing time, or any negative or positive external influences. Once the appraiser clicks a submit button, the appraiser will view the edit report screen, FIG. 14.

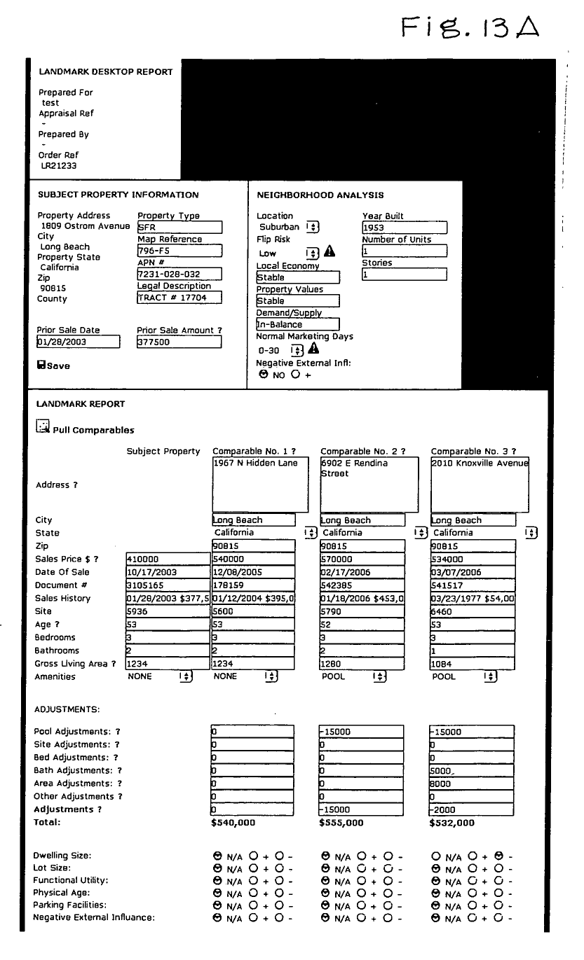

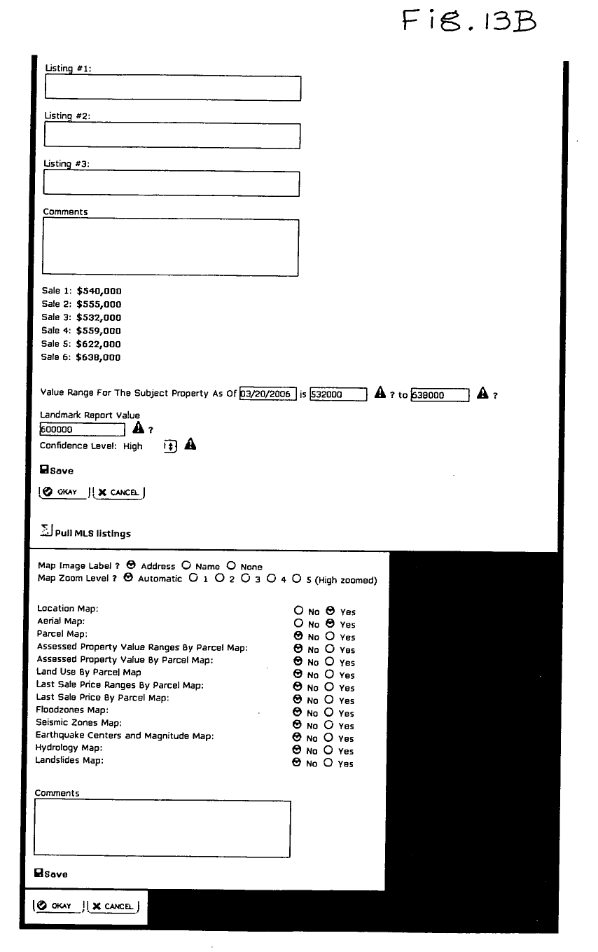

FIGS. 13A and 13B represent the search/edit report screen which enables the appraiser 40 to input/edit additional information regarding the retrieved sales information. The appraiser 40 can review and modify adjustments that were automatically calculated and populated into the preliminary report shown on this screen. The appraiser 40 sets a value estimate for the subject property, as well as a confidence level: low, moderate, or high. Based upon appraiser adjusted comparable sales information, the operating algorithm 70″ generates an estimated price range for the subject property. This establishes a preliminary report. When the appraiser 40 is satisfied with the preliminary report he/she moves back to the order detail screen, to generate a final report as a PDF document. The operating algorithm 70″ inserts comments into the final report based upon information that is placed on the report edit screen by the appraiser. These comments add a personal and professional touch to the final report, and define and describe certain characteristics of the subject property as well as comparable sales information. This PDF document is saved, archived and uploaded to the tracking system automatically.

FIG. 14 is the non-conclusive generation screen which the appraiser 40 uses for a subject property when it is not possible to produce a final report. If the appraiser 40 cannot create a credible final report, he/she is able to link to this screen by clicking on a Create Non-Conclusive link on the order detail screen. By submitting this form, a non-conclusion report is generated and stored. This report includes the aerial image and a location map of the subject property and the available comparable sales. It also provides all available data that has been produced in the appraisers effort.

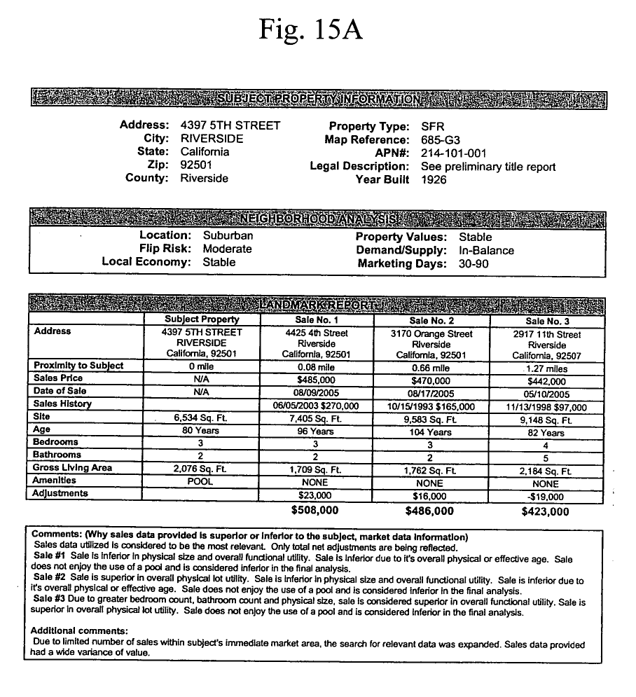

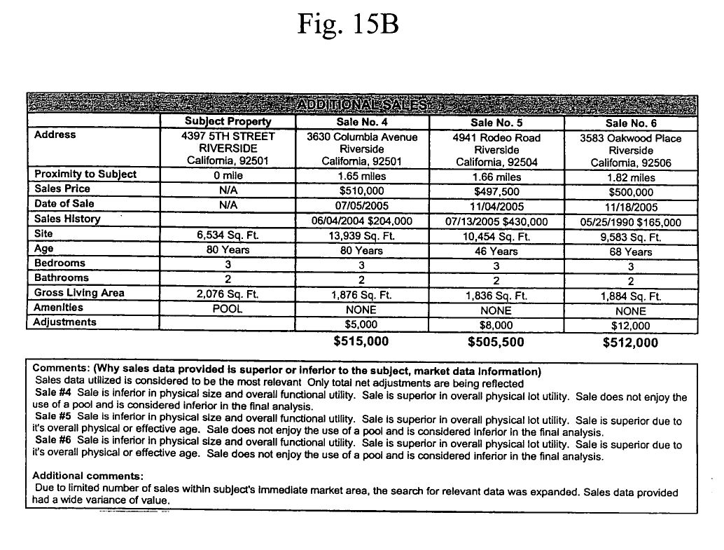

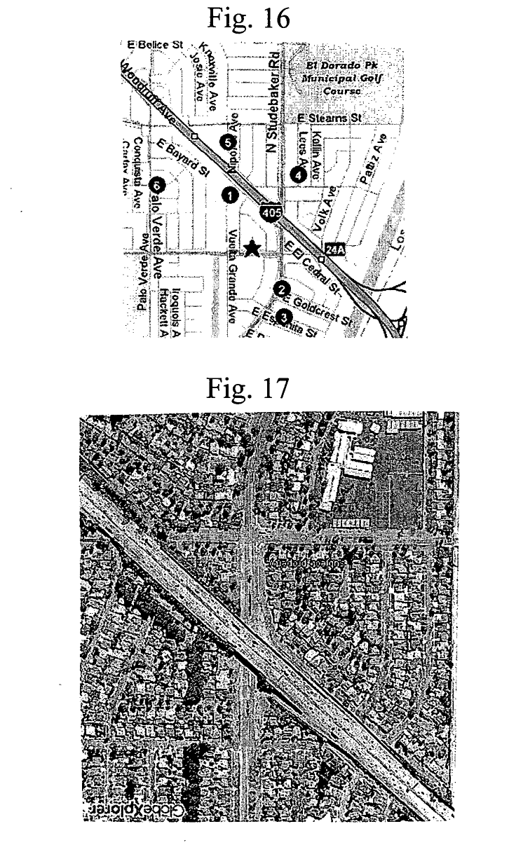

FIGS. 15A, 15B, 16, 17 represent a typical appraisal final report developed according to the present invention method. FIGS. 15A and 15B are the first and second pages respectively of such a report and shows information about recent comparable properties sold as well as current comparable listings. FIG. 16 is a third page of the report showing a street map locating the comparable sold and listed properties as well as the subject property; and FIG. 17 is a fourth page of the report showing an aerial map of the local vicinity surrounding the subject property.

The finished report typically includes the following elements:

1. Comments: Property address, property type, year built, number of units, stories, building type, map reference, APN#, legal description, prior sale date and amount, neighborhood type, flip risk, local economy, property values, demand/supply balance, typical days to sell.

2. Comparison Chart and Comments for Previously Sold and listed Properties and Sales Information comparing the subject property with one or more similar properties including proximity, price, date of sale, 3 year sales history, size of lot sq. ft., age, number of rooms, living area in sq. ft., amenities and an estimate of adjustments.

3. Location Map: This map is a street map showing streets, parks, highways and other features within a few miles of the subject property.

4. Arial Map: A photo taken at about one or two thousand feet elevation above the subject property showing buildings, trees, streets and other features of about a one mile square area.

5. Summary of Factors Considered: A check-off sheet listing the appraisal factors that were considered in making the report and whether the factors were acceptable or not, or if they were not a consideration in preparing the report.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A method of information exchange through an Internet web site comprising the steps, executed on the web site, of:
a) enabling access to the web site to registered users including clients, administrators and appraisers;
b) posting requests for property appraisal reports by the clients;
c) assigning the appraisal reports to the appraisers by the administrators;
d) collecting information from third party information databases by the appraisers;
e) formulating the appraisal reports by the appraisers;
f) approving the appraisal reports by the administrators; and
g) configuring the reports in readiness for uploading to the clients.

2. The method of claim 1 further comprising the step of placing an entry screen on the web site.

3. The method of claim 1 further comprising the step of placing an introductory screen providing initial advice on the web site.

4. The method of claim 1 further comprising the step of placing a new user registration screen on the web site.

5. The method of claim 1 further comprising the step of placing a log-in screen on the web site.

6. The method of claim 1 further comprising the step of placing a new order entry screen on the web site, the new order entry screen enabled for receiving essential items filled in by the client to define a property for reporting.

7. The method of claim 6 further comprising the step of placing an order status screen on the web site, the order status screen enabled for allowing the clients to view only their own outstanding orders and to further view respective order status thereof.

8. The method of claim 1 further comprising the step of placing a management screen on the web site, the management screen showing active and registered users, and limiting access to only certain management administrators.

9. The method of claim 1 further comprising the step of placing an administrator screen on the web site, the administrator screen showing all current orders in a first section thereof and orders currently in-process in a second section thereof.

10. The method of claim 9 further comprising the step of enabling timers associated with the orders thereby providing a means for managing the orders.

11. The method of claim 1 further comprising the step of placing a search screen on the web site, the search screen enabled for searching the database by search variables: borrower name, file number, status, address, and date of order.

12. The method of claim 7 further comprising the step of placing a comparables search screen on the web site, comparables screen enabling the setting of parameters for controlling a sales information data search for a subject property.

13. The method of claim 12 further comprising the step of auto-populating a search result of sales information data from calculated variances based on details of the subject property.

14. The method of claim 13 further comprising the step of placing a comparables search results screen on the web site, said screen showing data and information resulting from third party information databases thereby enabling appraisers to select sales data for the report.

15. The method of claim 14 further comprising the step of placing a search and edit report screen on the web site, said screen enabling the appraiser to input and edit additional information regarding the retrieved sales information, and review and modify adjustments that were automatically calculated and populated into the preliminary report.

16. The method of claim 15 further comprising the step of setting a value estimate for the subject property and a confidence level.

17. The method of claim 16 further comprising the step of generating an estimated price range for the subject property.

18. The method of claim 1 further comprising the step of placing a non-conclusive generation screen on the web site.

19. The method of claim 17 further comprising the step of generating a final report showing information about recent comparable properties sold as well as current comparable listings, a street map locating the comparable sold and listed properties as well as the subject property; an aerial map of the local vicinity surrounding the subject property, and comments including at least one of: property address, property type, year built, number of units, stories, building type, map reference, APN#, legal description, prior sale date and amount, neighborhood type, flip risk, local economy, property values, demand/supply balance, typical days to sell.
